(19) United States
(12) Patent Application Publication
(10) Pub. No.: US 2007/0037441 A1
(43) Pub. Date: Feb. 15, 2007

(54) Layman's electrical assistant

(76) Inventor: Richard S. Onstott, Anchorage, AK (US)

Correspondence Address: Richard S. Onstott, 3325 Lake Park Circle, Anchorage, AK, 99517, US

(21) Appl. No.: 11/367,251

(22) Filed: Mar. 2, 2006

Related U.S. Application Data
(60) Provisional application No. 60/708,460, filed on Aug. 15, 2005.

(51) Int. Cl. H01R 11/00

(52) U.S. Cl. 439/505

(57) ABSTRACT

The Layman's Electrical Assistant (LEA) is a safe, easy, reliable electrical information gathering and troubleshooting tool for Homeowners and other Laypersons. It can be used: 1. to determine whether electrical energy (Voltage) is or is not present at a receptacle, 2. to observe the amount of alternating current (in AC Amps per hour), up to 19.99 Amps, as it is used to power individual house-hold appliances and other small cord supplied electrical equipment and devices (in order to determine operability or condition) and, 3. to manage the size and number of devices (LOAD) connected to a cord or branch circuit, supplying more than one receptacle, to prevent overloading that can cause nuisance circuit breaker tripping, blown fuses or extension cord melt down and possibly fire.

### BACKGROUND OF THE INVENTION

This invention relates to devices used throughout the electrical/electronics industries for measuring the force and flow of electricity; but most specifically to instruments, called Ammeters, utilized by Electricians to observe the amount of current used, in amperes, as it flows through electrical conductors to power equipment. They are manufactured, in both fixed and portable styles with either analog or digital readout, under several brand names.

The instrument commonly used by electrical tradesmen to determine the amount of electric current, in amperes (Amps.), being used by a piece of equipment or circuit (Load) is commonly called a clamp-on (style) or Amprobe (trade name). It is a portable ammeter that has selective ranges, from zero to its maximum design capability, and must be clamped around the hot lead (wire) of the circuit under test to obtain a reading. This necessitates opening a panel or a box to gain access to the hot lead or the fabrication of a device to extend and expose the hot lead. In either case, it requires the expertise of an electrician or someone with electrical talent that far exceeds the knowledge of most laymen. So; from the standpoint of Safety, it is generally agreed that no-one but a certified electrician be allowed to perform that kind of task.

In summation:

The foregoing clearly illustrates the need for a safe, simple, reliable device with which the average home owner or other layperson can easily do some load safety checks and limited troubleshooting before having to go to the expense of hiring electrical work done.

### BRIEF SUMMARY OF THE INVENTION

The “Layman's Electrical Assistant” (LEA), is specifically designed, for home owners and other laypersons, to provide a safe, easy method for measuring electrical usage during the operation of household appliances and other types of cord supplied electrical equipment. The LEA combines a Digital AC ammeter with other components to give a visual indication of power consumed, in amperes per hour (Amps), by equipment powered via 120 VAC, 15 or 20 Amp receptacles. The Ammeter's Display Window will light up with Red LED Digits of 0.00 as soon as the LEA is plugged into a live (hot) receptacle, indicating to the user that power is available to the Switch of the On-Deck Receptacle. When a device is plugged into the LEA On-Deck Receptacle and the Switch is turned “ON”, the Switch Position Indicator Light illuminates and digits indicating the Amps per hour being used to run the equipment will be displayed in the Ammeter's Display Window in place of the initial 0.00 reading. The same procedure is followed to find out if a piece of equipment is operating within factory spec, to back track to the source of a power loss, to pinpoint the cause of nuisance breaker tripping, and to regulate loads on extension cords and branch circuits to within their rated capacities, etc. . . .

Combined with a simple trouble-shooting guide, written Lay terms (as devoid of technical jargon as possible), and some easy conversion formulas (for those who wish to know more), users will find this a valuable tool that not only can save them money but will also provide them with a margin of safety, since they will be able to determine if they have too many lights on that Christmas tree or too light an extension cord for that portable electric heater, etc. . . .

### BRIEF DESCRIPTION OF THE DRAWINGS

FIG. 1 is a dimensional drawing showing exterior appearance and component placement of the working model of the Layman's Electrical Assistant (LEA), a simple Digital AC Ammeter and electrical troubleshooting instrument for Home Owners and other Laymen.

FIG. 2 is an electrical schematic symbolically showing components of FIG. 1 and how they are electrically connected.

FIG. 3 is a dimensional drawing showing another possible embodiment of FIG. 1. The enclosure has a fixed, case mounted plug instead of the power cord and cord end plug. Other configurations are bound to evolve as technological advances in miniaturization take place.

FIG. 4 is an electrical schematic symbolically showing components of FIG. 3 and how they are electrically connected.

### DETAILED DESCRIPTION OF THE INVENTION

The Layman's Electrical Assistant (LEA) is specifically designed to provide a safe, easy and reliable way for home owners and other laypersons to do some simple electrical trouble shooting that could save them the cost of hiring an electrician to find out that a switch was turned off, a breaker was tripped, the unit was just unplugged, the toaster is shot or there are too many lights on an extension cord, etc. To measure the amount of electricity used, during the operation of household appliances and other types of cord supplied electrical equipment; this invention combines a Digital AC Ammeter with other components to give a visual indication of power consumed, in amperes, by equipment being energized from a single power outlet (receptacle). The LEA plugs into any two pole, three wire, 120 Volt AC, 15 or 20 Amp receptacle and displays the amount of electric power, from 0 to 19.99 Amps, being used by any device plugged into the LEA On-Deck Receptacle. The easy to read Red LED Digital Display is the first indication of whether voltage is (0.00 displayed) or is not present at the receptacle the LEA is plugged into. A small Pilot Light, built into the LEA On-Deck Receptacle Unit, indicates whether the Switch is turned on or off.

Details of the working prototype and a second embodiment are described as follows:

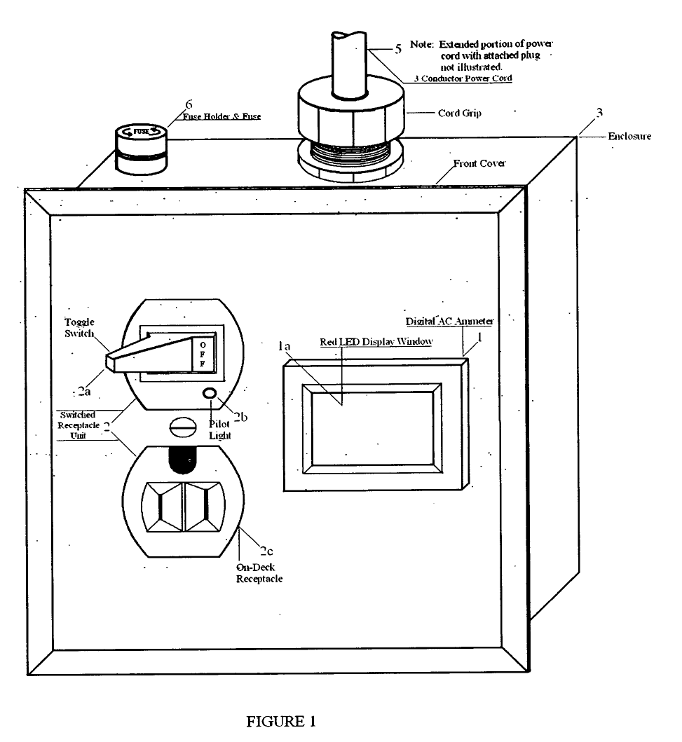

FIG. 1 is a dimensional drawing illustrating the external views of the enclosure and the components as they appear on the front panel and top of the case. Descriptions are given and numbers are assigned that correspond to the component designations in the following electrical schematic.

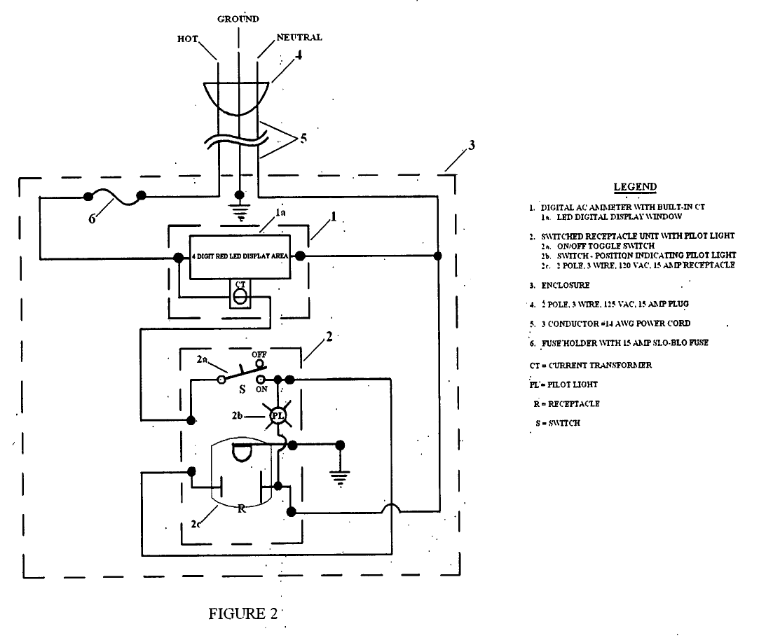

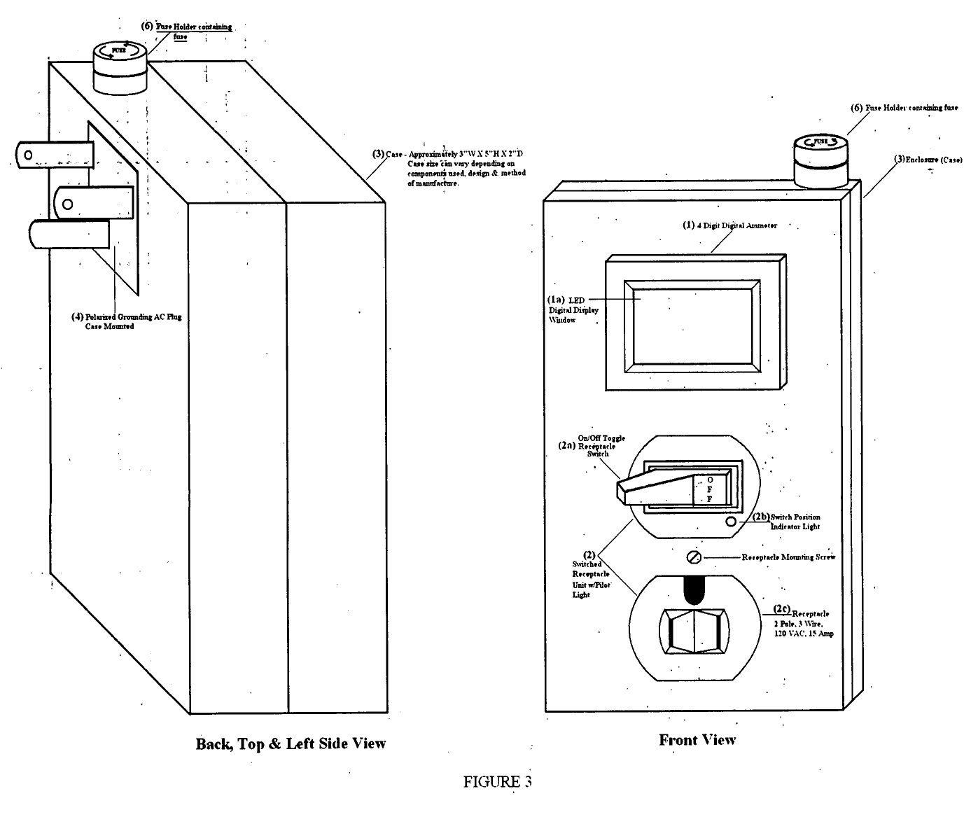

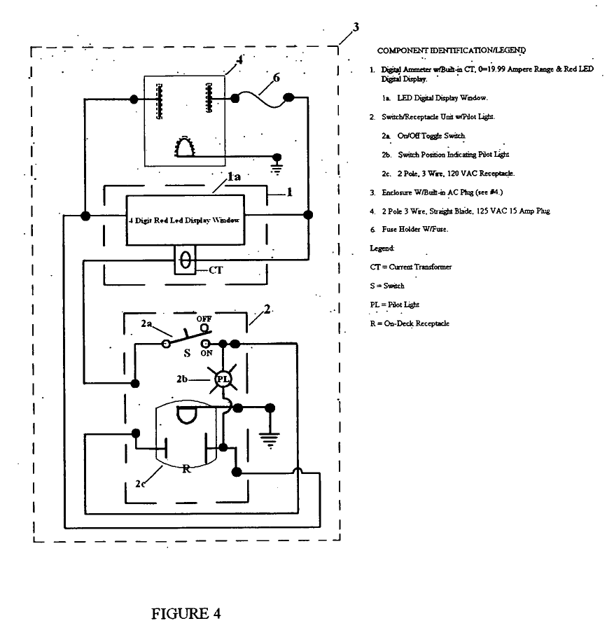

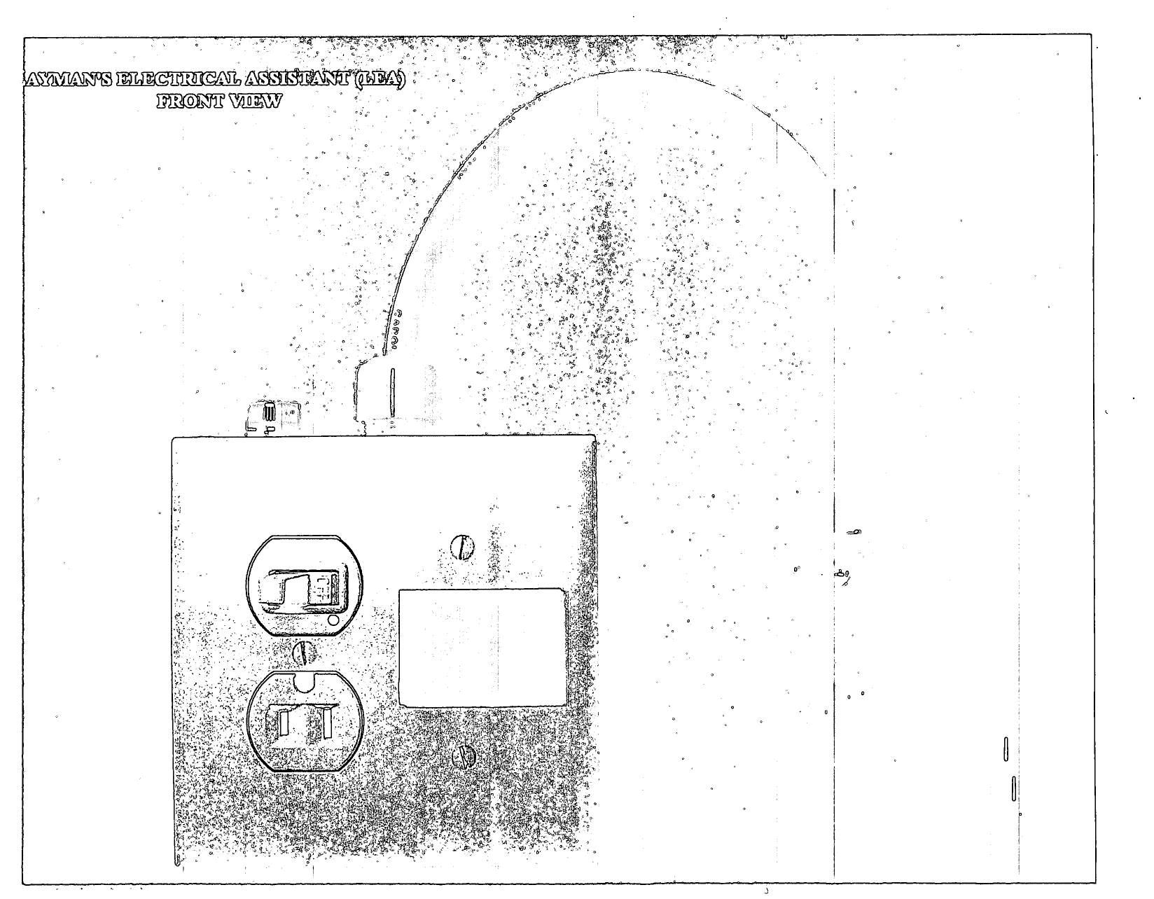

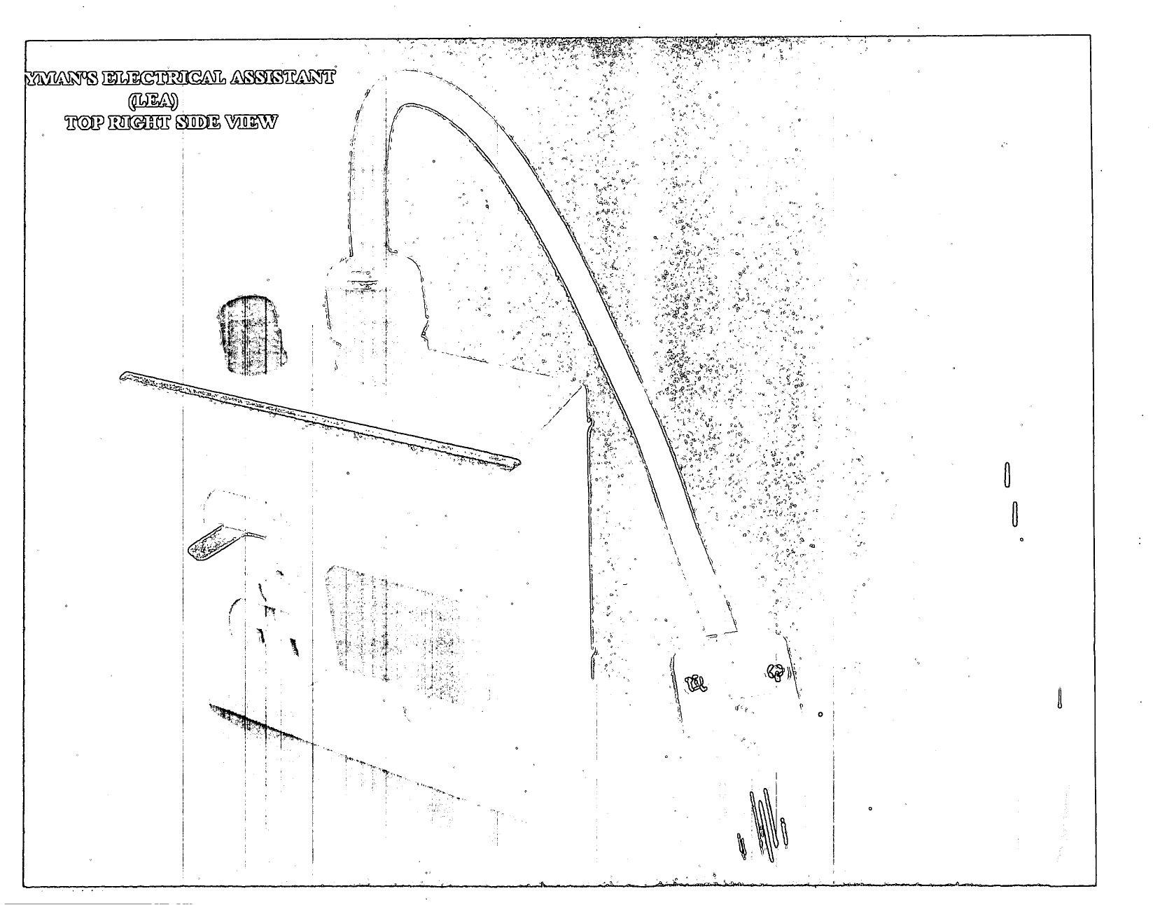

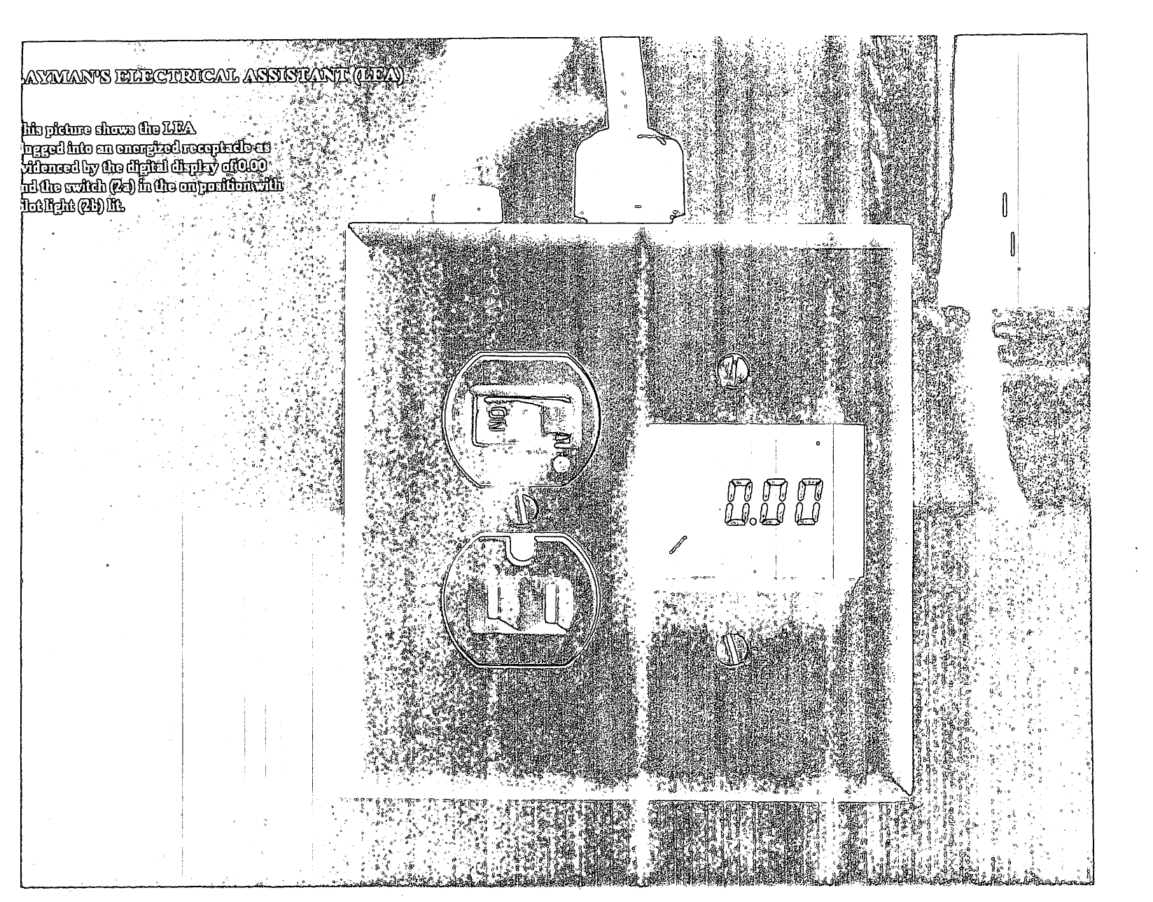

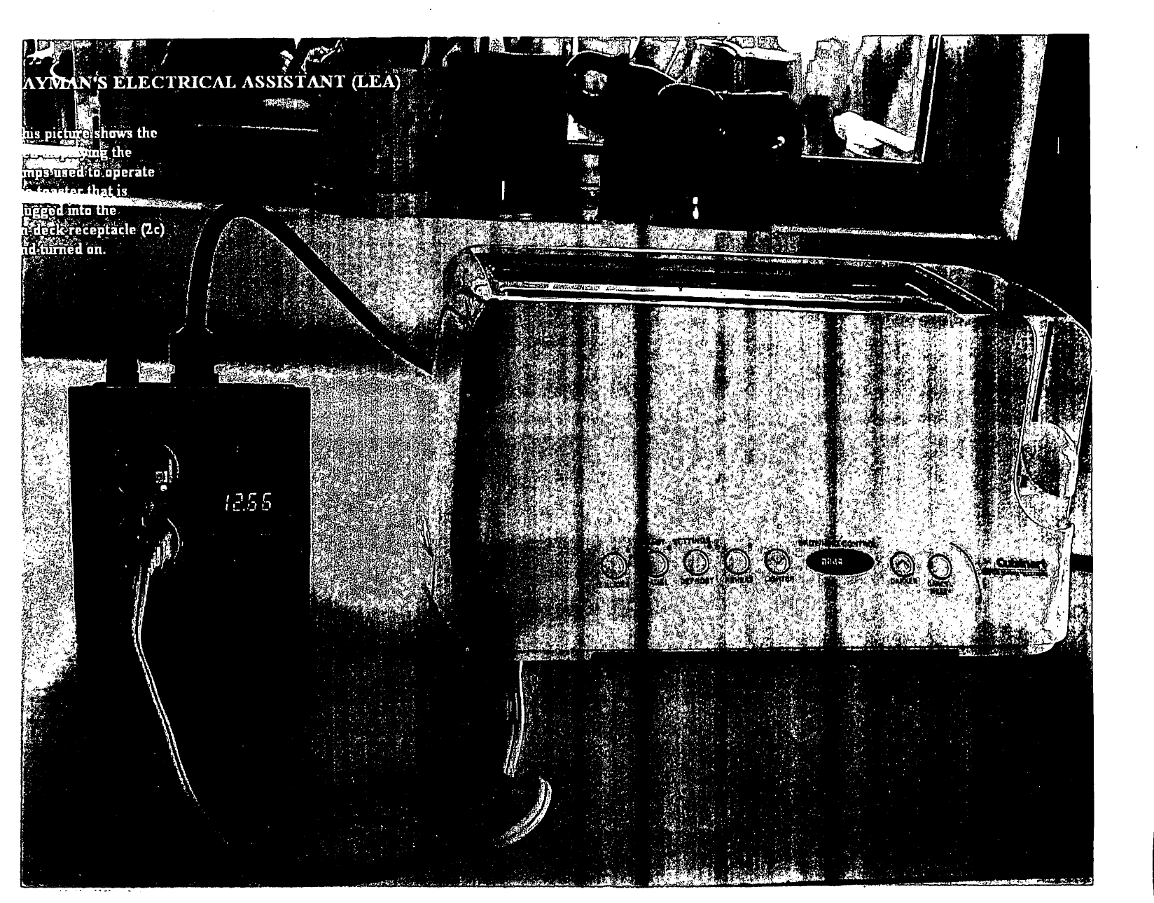

FIG. 2 is an electrical schematic that symbolically illustrates the components used to create the LEA, how they are interconnected within enclosure (3) and how they are energized through a three conductor Power Cord (5). A straight blade two pole three wire, 125 volt AC Plug (4) is connected to the cord's bitter end and the three conductors (Hot, Ground and Neutral) that emerge from the cord within the enclosure are connected to components as shown. When the Plug (4) is inserted into a mating 15 or 20 Amp wall receptacle or cord end connector that is energized, voltage is applied through Fuse (6) to the positive side connection of the Digital AC Ammeter (1) and Red LED Digits 0.00 light-up indicating that voltage is present and the AC circuit is complete to the negative side of Digital Ammeter (1) which is connected to AC Neutral (Common). A conductor connected to the positive side of Ammeter (1) is routed through the built-in Current Transformer (CT) to the Switched Receptacle Unit (2) and connects to the designated terminal of Switch (2a). From the other side of the Switch (2a), a jumper wire is connected to the Hot terminal of On-Deck Receptacle (2c) and the Common terminal of Receptacle (2c) is connected to AC Neutral (Common). The grounding terminal of Receptacle (2c) and the incoming grounding conductor from Plug (4) are connected to a common terminal within enclosure (3), since the enclosure may not be made of a material that would assure conductivity. The Pilot Light (2b) is a switch position indicator that lights when voltage is applied by the closing of Switch (2a) to energize Receptacle (2c).

FIG. 5 is a dimensional drawing of another possible embodiment of FIG. 1. It changes the type of Enclosure (3) to a more compact style with a molded or otherwise fixed 2 Pole, 3 Wire Straight Blade, 125 VAC 15 Amp Plug on the back of the case in lieu of the 3 Wire #14 AWG Power Cord and Cord End Plug used with FIG. 1. Otherwise it is identical in function to the working prototype shown in FIG. 1

FIG. 6 symbolically shows the electrical components of FIG. 5 and how they are connected within the Enclosure (3) to complete the unit. With the exception of the Power Plug differences described in FIG. 5, all connections and components are as depicted in FIG. 2.

The LEA; accompanied by well written instructions, that include a simple troubleshooting guide and some easy to understand electrical conversion formulas, will be an extremely useful instrument for use in the home, at the office and as a quick diagnostics tool for small appliance repairmen.

### Operation

The LEA Plug (4) can be plugged into any standard two pole, three wire, 120 VAC, 15 or 20 Amp. receptacle; but, if the purpose of the exercise is to check the operation of a particular device, then it is preferable to plug (4) into the receptacle from which the device in question has been unplugged. If the receptacle is energized, a Red LED Digital Display of 0.00 will illuminate in Window (1a) of Digital Ammeter (1), alerting the operator to the presence of power to that point. With Switch (2a) of Switched Receptacle Unit (2) in the off position (Pilot Light (2b) not lit), the cord-end plug of a household appliance or other cord connected electrical device is plugged into the On-Deck Receptacle (2c) and Switch (2a) is turned on (Pilot Light (2b) lit). The device being checked is turned on; and if it is functioning, the Red LED Digital Display in Window (1a) will increase from 0.00 to a new value, in Amps, of the amount of electric current the device is using. This reading indicates that the unit is working and how well can be determined by comparing the digital Amps reading to the Full Load Amps (FLA) rating shown on the equipment's nameplate or in the power specifications of the technical data section of the operating manual. When an extension cord supplying multiple devices, such as ornamental strings of lights and/or mobile decorations, is plugged into the LEA On-Deck Receptacle (2c), the Red LED Digital Amps reading observed in the Display Window (1a) can be checked against the Amp rating of the extension cord to determine whether some devices need to be removed or more can be added. As devices are added or removed, the User can observe the changes in the Amp reading amplitude and adjust the number of devices (Load) up or down as necessary to stay within the factory specified Amp rating of an extension cord, branch circuit breaker or other upstream in-line device that might be sensitive to overload.

I claim:

1. A safe, easy, reliable method, for homeowners and other laypersons to obtain electrical information pertinent to appliances and other cord supplied equipment in their homes or offices, the embodiment of which provides the following:
a.) A means for managing the size of electrical loads (total amperage of multiple electrical devices connected to one extension cord or branch circuit), such as decorative lighting, lighted/mobile displays, more than one appliance operating simultaneously on the same circuit, etc. . . .
b.) A tool with which to perform minor electrical troubleshooting tasks to determine the operating condition appliances and other cord connected equipment, from coffee makers and toasters to computers and weed whackers.
c.) An instrument with which to do minor troubleshooting tasks that may well spare the user the expense of hiring a professional electrical serviceman to discover that a switch was turned off, a breaker was tripped, or the extension cord got hot because too many Christmas light strings were plugged into it and so forth.
